(19) United States
(12) Patent Application Publication
(10) Pub. No.: US 2026/0369783 A1
(43) Pub. Date: Nov. 19, 2026

(54) HOUSING FOR POWER ELECTRONIC DEVICE

(71) Applicant: TI Group Automotive Systems, LLC, Auburn Hills, MI (US)

(72) Inventors: Justin BEKKER, Waterford, MI (US); Jonathan Glen HOLTZ, Clarkston, MI (US); Andy SUTHERLAND, Birmingham, MI (US)

(21) Appl. No.: 19/155,384

(22) PCT Filed: Feb. 9, 2023
(86) PCT No.: PCT/US2023/062271

§ 371 Date: Aug. 11, 2025

(51) Int. Cl. H01M 50/249; B60L 50/60

(52) U.S. Cl. CPC H01M 50/249; B60L 50/60; H01M 2220/20

(57) ABSTRACT

A housing for a power electronic device includes an upper enclosure having an upper body and an upper flange extending outward from the upper body and a lower enclosure having a lower body and a lower flange extending outward from the lower body. The upper and lower flanges are each defined with a length along a longitudinal plane of the flanges and materially bonded together along only an outer portion of the length to form a bonded part that seals and encloses the power electronic device, and upon removing the bonded part of the flanges, the upper and lower flanges having a remaining length that can be re-bonded to again enclose the power electronic device. Accordingly, the housing can be reused to enclose the power electronic device after servicing the power electronic device.

### FIELD

The present disclosure relates to a housing for a power electronic device, and more particularly to a reusable housing for the power electronic device.

### BACKGROUND

The statements in this section merely provide background information related to the present disclosure and may not constitute prior art.

Recently, high voltage batteries are being widely used in vehicles such as hybrid electric vehicles (HEVs) and electric vehicles (EVs). In particular, with the steady exhaustion of carbon energy and increasing interest in the environment, the demand for the hybrid electric vehicles and the electric vehicles is increasing all over the world. In such hybrid electric vehicles or electric vehicles, the most essential component is a battery pack that gives driving power to an automobile motor. Because hybrid electric vehicles or electric vehicles are supplied with power for driving the vehicles through charging/discharging of battery packs, they have higher fuel efficiency and can eliminate or lessen the emission of pollutants, and by this reason, the number of users for driving the hybrid electric vehicle or electric vehicle is now increasing.

When the high voltage batteries are used in an electric vehicle or a hybrid electric vehicle, the high voltage batteries are enclosed by an enclosure to structurally and safely support the high voltage batteries used in the hybrid electric vehicle or electric vehicle. Current enclosures for the high voltage batteries or other power electronic devices require many fasteners to join the cover to the tray which requires a long cycle time, individual sealing to prevent moisture from entering the enclosure, and a large number of components and features. However, we have discovered that these fasteners have the potential to be removed by the general public which can be a safety risk and also a consumer improperly attempts to service the batteries or other high voltage components inside the enclosure. Alternatively, permanently joined enclosures do not offer any option for re-assembly when the batteries or other high voltage components need to be serviced throughout the life of the vehicle requiring the entire assembly to be scrapped in case service is needed. Accordingly, it is desirable that a reusable housing to enclose the high voltage batteries or other power electronic devices is used after the service of the high voltage batteries or other power electronic devices. Further, the battery cells (the high voltage batteries) are generally degraded by the long cycle time and the number of recharging cycles, and hence might need to be replaced. Accordingly, instead of replacing the battery assembly including the housing integrated into the vehicle structure, it is desirable that only the battery cells inside the housing are replaced because it is cheaper and easier.

### SUMMARY

The present disclosure relates to a reusable enclosure for a power electronic device such as a battery. According to an exemplary aspect of the present disclosure, a housing for a power electronic device includes an upper enclosure having an upper body and an upper flange extending outward from the upper body and a lower enclosure having a lower body and a lower flange extending outward from the lower body. The upper and lower flanges are each defined with a length along a longitudinal plane of the flanges and materially bonded together along only an outer portion of the length to form a bonded part that seals and encloses the power electronic device, and upon removing the bonded part of the flanges, the upper and lower flanges having a remaining length that can be re-bonded to again enclose the power electronic device.

According to a further aspect of the present disclosure, the housing includes at least two bonding zones spaced apart on the length of the flanges along the longitudinal plane and at least one non-bonding zone located between the at least two bonding zones. In a pre-service state of the housing, the upper and lower flanges are attached at least at sections of the perimeters of the flanges by materially bonding in an outermost bonding zone.

According to a further aspect of the present disclosure, removing the outermost bonding zone on the flanges provides access the power electronic device inside the housing such that it can be serviced. The bonded outermost bonding zone of the flanges is removed by cutting an adjacent portion of the at least one non-bonding zone in the longitudinal plane.

According to a further aspect of the present disclosure, in a completed post-service state of the housing, the upper and lower flanges are re-bonded in the other bonding zone arranged in the remaining length of the flanges. The other bonding zone has become a second outermost bonding zone via removal of a first outermost bonding zone in a pre-service state of the housing.

According to a further aspect of the present disclosure, each of the bonding zones includes weld seams pre-formed on each of the upper and lower flanges such that the weld seams are fused together to attach the upper and lower flanges when welded.

According to a further aspect of the present disclosure, the upper and lower enclosures are formed of a thermoplastic polymer material. The upper and lower enclosures are attached to each other by one of the material bonding methods such as a welding or a gluing with an adhesive material.

According to a further aspect of the present disclosure, the at least two welding zones and the at least one non-welding zone are each arranged around perimeters of the upper and lower flanges. Further the upper and lower enclosures attached by welding around perimeters of the flanges are sealed to prevent moisture from entering the housing.

According to another aspect of the present disclosure, the method for reusing a housing for the power electronic device includes the steps of providing an upper enclosure formed with an upper flange, providing a lower enclosure formed with a lower flange, arranging a first welding zone and a second welding zone spaced apart by a non-welding zone around perimeters of a portion of the upper and lower flanges along a longitudinal plane of the flanges, attaching the upper and lower enclosures by welding in the first welding zone located in an outermost portion of the upper and lower flanges, removing the first welding zone on the upper and lower flanges such that the upper and lower enclosures are detached from each other and the power electronic device can be accessed, and attaching the upper and lower enclosures by re-welding in the second welding zone on the upper and lower flanges to enclose again the power electronic device. Further, the step of removing the first welding zone on the flanges further includes the step of the cutting a portion of the non-welding zone defined between the first and second welding zones such that the first welding zone and the portion of the non-welding zone are removed. The present disclosure is not limited to two welding zones formed in the flanges of the upper and lower enclosures (see FIGS. 1 and 1A).

According to a further aspect of the present disclosure, the housing is used to enclose at least one battery pack such as a high voltage battery pack. Further, the housing having the power electronic device is used in a hybrid electric vehicle (HEV) or an electro mobility (e-Mobility).

Further details and benefits will become apparent from the following detailed description of the appended drawings. The drawings are provided herewith purely for illustrative purposes and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 shows a plan view of a housing having a high voltage battery in accordance with an exemplary embodiment of the present disclosure, and FIG. 1A shows a cross-sectional view of the housing having the high voltage battery, taken along line 1A-1A in FIG. 1;

FIG. 2 shows a portion of the cross-sectional view of the housing having the high voltage battery in a pre-service state of the housing in accordance with another exemplary embodiment of the present disclosure;

FIG. 3 shows the portion of the cross-sectional view of the housing having the high voltage battery of FIG. 2 in a post-service state of the housing; and

FIG. 4 shows the portion of the cross-sectional view of the housing having the high voltage battery of FIG. 2 in a completed post-service state of the housing.

The drawings described herein are for illustration purposes only and are not intended to limit the scope of the present disclosure in any way.

### DETAILED DESCRIPTION

The following description is merely exemplary in nature and is in no way intended to limit the present disclosure or its application or uses. It should be understood that throughout the drawings, corresponding reference numerals indicate like or corresponding parts and features.

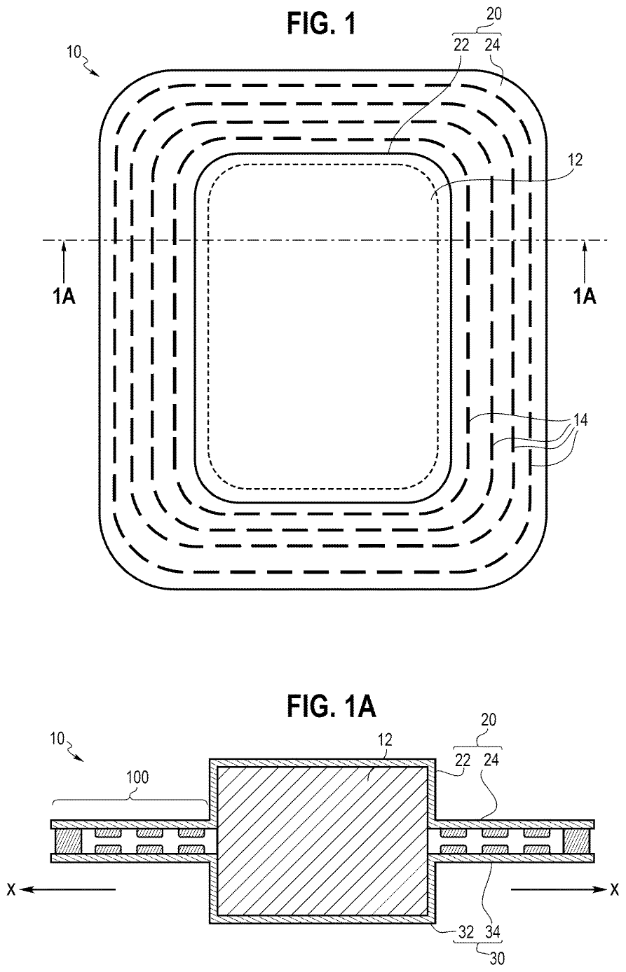

FIG. 1 shows a top view of a housing (i.e. an enclosure) 10 enclosing a power electronic device 12 such as a battery cell having a high voltage battery, etc., and FIG. 1A shows a cross-sectional view of the housing 10 with the power electronic device 12 inside the housing 10. Recently, the high voltage battery has a wide range of applications, and for example, may be used as a power source for at least one medium- and large-scale device of the power tools: electric cars including electric vehicles, hybrid electric vehicles, and plug-in hybrid electric vehicles; electric truck; electric commercial vehicles; and energy storage systems, etc. Further, for using the high voltage battery in the wide range of applications listed above, the high voltage battery is generally enclosed by the housing 10 to structurally support the high voltage battery and also to prevent moisture from entering the enclosure through the life of the electric systems. In addition, the battery cells might be embedded in the coolant flow such that the battery cells are also enclosed by the housing to prevent the leakage of the coolant.

As shown in FIGS. 1 and 1A, the housing 10 is formed with an upper enclosure 20 and a lower enclosure 30 to enclose the power electronic device 12. Further, the upper enclosure 20 is formed with an upper body 22 and an upper flange 24 around the perimeter of the upper body 22, and the lower enclosure 30 is formed with a lower body 32 and a lower flange 34 around the perimeter of the lower body 32. In particular, as shown in FIG. 1A, the upper enclosure 20 and the lower enclosure 30 are faced and attached to each other on both flanges 24 and 34 to form the housing 10 such that the power electronic device 12 is stored inside the housing 10. Further, the upper enclosure 20 and the lower enclosure 30 are attached by one of the bonding methods such as a welding or gluing with an adhesive material. As shown in the exemplary embodiment of FIG. 1, the pre-formed welding beads 14 may be applied on the flanges 24 and 34 around the perimeter of the flanges (see FIG. 1), each upper and lower pair of which can be used to seal the housing 10 such that it prevents moisture from entering the housing 10 or the leakage of the coolant inside the housing 10. However, in accordance with other forms of the present disclosure, different welding methods or other material bonding methods (e.g., a gluing with an adhesive material), and their various related material compositions, may be used to attach the upper and lower enclosures 20 and 30 and also to seal the housing 10 for preventing moisture from entering the housing 10 and/or the leakage of the coolant.

For example, various welding methods such as an ultrasonic plastic welding (USW), a vibration (friction) welding, a laser welding, a spin welding, an infrared (IR) welding, or a hot plate welding may be used to attach and seal the housing 10. The ultrasonic plastic welding is the joining or reforming of the thermoplastic through the use of heat generated from high-frequency mechanical motion. The vibration (friction) welding uses rapid linear motion to create friction and heat at the joint interface of the parts to be mated, and then the plastic solidifies under clamping pressure and forms a permanent bond. The laser welding is a welding method used to join pieces of metal or thermoplastics through the use of a laser. The laser beam provides a concentrated heat source, allowing for narrow, deep welds and high welding rates. The spin welding process is generating heat by rotational friction to weld thermoplastic parts by melting the parts. The infrared welding uses a non-contact heating method to melt and fuse thermoplastic parts together using the energy from infrared radiation. The hot plate welding is a thermal welding process for joining thermoplastics by melting and joining the parts under pressure.

As shown in FIG. 1, the housing 10 is generally formed with a rectangular or square shape, but in another approach, the housing 10 may be formed with other shapes according to the shape of the power electronic device or the location where the housing is placed. Likewise, the housing can be shapes other than square or rectangular, e.g. a circular shape would provide a good situation for spin welding the two enclosure portions together along the periphery in the area of the flanges.

In the attached enclosures 20 and 30 of FIG. 1A, the upper body 22 and the lower body 32 are formed as a box type to enclose the power electronic device 12, and the upper and lower flanges 24 and 34 are each formed around the perimeter of the respective upper body 22 and lower body 32. Further, each flange 24 and 34 extends outward from the perimeter of each body 22 and 32 in a longitudinal plane along X-axis (see FIG. 1A), and the upper flange 24 and the lower flange 34 are materially bonded to each other for sealing the housing 10. Preferably, in an initial configuration, the outermost pair of upper and lower welding beads are used to weld the two enclosures 20, 30 together and seal the housing 10 from the exterior. Generally, the upper and lower enclosures 20 and 30 are each formed of thermoplastic polymer materials such as polyamides, polyolefins, TPU, polyesters, etc. Also, the upper and lower enclosures are formed of multilayer structures of these materials listed above. However, in accordance with other forms of the present disclosure, the enclosures 20 and 30 are each formed of other materials (e.g., bio-based and recycled materials of these materials listed above) to structurally support the power electronic device 12.

As shown in FIGS. 1 and 1A, each of the upper and lower flanges 24 and 34 extends approximately with a length, L in the longitudinal direction of the flange (i.e. along X-axis) around the perimeter of the upper and lower bodies 22 and 32, and multiple bonding zones (e.g., multiple welding zones 100 in FIG. 1A) are each formed on the upper and lower flanges 24 and 34 along the longitudinal plane (i.e., X-axis in FIG. 1A) around the perimeter of the flanges such that the housing 10 having the multiple welding zones 100 on the flanges 24 and 34 can provide for accessing the power electronic device 12 inside housing 10 multiple times throughout the life of the power electronic device 12. In another approach, the bonding zones at the both flanges could be partly formed around the perimeter of the flanges such that the bonding zones are formed in some sections of the flanges. Accordingly, the upper and lower enclosures are attached to each other by the combination of latching (e.g., form and force fitting) disposed in some sections of the flanges and the material bonding (e.g., welding or gluing) in other sections of the flanges. Due to the housing 10 having the multiple welding zones 100 (e.g., four welding zones) as shown in FIG. 1A of the present disclosure, the housing 10 enclosing the power electronic device 12 is allowed for serviceability of the power electronic device 12 when the power electronic device 12 inside the housing 10 needs to be checked or fixed, and further replaced.

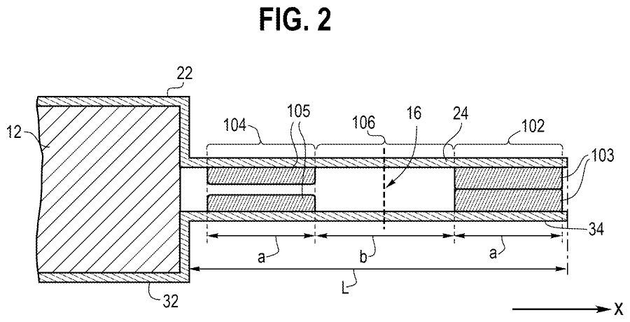

FIG. 2 is a portion of the cross-sectional view in accordance with another exemplary embodiment of the present disclosure. For example, FIG. 2 shows two welding zones such as a first welding zone 102 and a second welding zone 104 on the upper and lower flanges 24 and 34 along the longitudinal plane of the flanges. Particularly, the first welding zone 102 is located in an outermost region of the both flanges 24 and 34 (i.e., the farthest location from each of the upper and lower bodies 22 and 32 along the X-axis, an outermost welding zone) and the second welding zone 104 is located in an innermost region of the both flanges 24 and 34 (i.e., the closest location from each of the upper and lower bodies 22 and 32 along the X-axis, the other outermost welding zone after removing the first welding zone 102). Further, as shown in FIG. 2, one non-welding zone 106 is located between the first welding zone 102 and the second welding zone 104 along the X-axis. In the initial configuration, the outer welding zone 102 (i.e., the first welding zone) has pre-formed welding beads (of a thermoplastic polymer material) that are irradiated, heated or otherwise used to weld the upper and lower enclosures 22, 32 together. In this configuration, the second welding zone 104 does not have its welding beads connected together, and they remain separate and distinct.

The non-welding zone 106 is used as a cutting area 16 when a service (e.g. repair or replacement) is required to access the power electronic device 12 inside the housing 10 such that the first welding zone 102 is removed with a portion of the adjacent non-welding zone 106. During the service, and after cutting the first welding zone 102, the power electronic device 12 inside the housing 10 can be checked and/or fixed because the upper and lower enclosures 20 and 30 are separated from each other. After the service, the housing 10 is reused to enclose the power electronic device 12 by welding in the second welding zone 104 on the flanges 24 and 34 such that the upper and lower enclosures 20 and 30 are again attached to each other and resealed to prevent moisture from entering the housing 10.

Referring back to FIG. 1A, each welding zone includes weld seams (i.e., welding beads) to be fused together when each welding zone on the flanges needs to be welded. In FIG. 2, for example, the first welding zone 102 has first weld seams 103 arranged on the upper and lower flanges 24 and 34 and fused together to attach the upper and lower enclosures 20 and 30, and seal the housing 10. The upper and lower weld seams 103 are radially aligned relative to the device 12 and enclosure 10, i.e. they are equidistantly spaced from the enclosure 10 and device 12 along the X-axis so that they are horizontally aligned for the welding or bonding procedure. Further, the second welding zone 104 also has second weld seams 105 prearranged on the upper and lower flanges 24 and 34 to be radially or horizontally aligned such that after service, the second weld seams 105 are fused together to attach the upper and lower enclosures 20 and 30, and seal the housing 10 such that the housing 10 is reused to enclose the power electronic device 12. The weld seams 105 are pre-formed welding beads, rims or protrusions containing weldable material (a thermoplastic polymer material) than can be irradiated, heated, vibrated, spun or otherwise operated upon such that the upper and lower welding seams change their physical state (e.g. melt) such that they can be attached to each other in a sealed manner.

In particular, and with reference to FIG. 2, along the longitudinal plane, the first and second welding zones 102 and 104, and one non-welding zone 106 are arranged. In accordance with other forms of the present disclosure, more than two (2) welding zones and more than one (1) non-welding zone on both flanges may be disposed based on the length L of the flanges 24 and 34. Further, the length L of the both flanges 24 and 34 extending from each of the bodies 22 and 32 along the X-axis is approximately 3-30 mm, and preferably 20 mm. The length a of each of the welding zones 102 and 104 is approximately 0.3-10 mm, and preferably 5 mm. Further, the length b of the non-welding zone 106 is approximately 0.5-25 mm, and preferably 10 mm. In general, the length L of each flange is equal to or greater than the sum of the lengths a of the first and second welding zones 102 and 104, and the length b of the non-welding zone 106. Non-welding zone 106 does not contain any preformed welding seam or bead, and the opposing upper and lower portions are not directly connect. They can also be formed (fully or partially) of other materials that are not suitable for welding or bonding using the selected technique(s) for the welding zones 102 and 104. In this case, the length of the non-welding zone is approximately 0.1-10 mm.

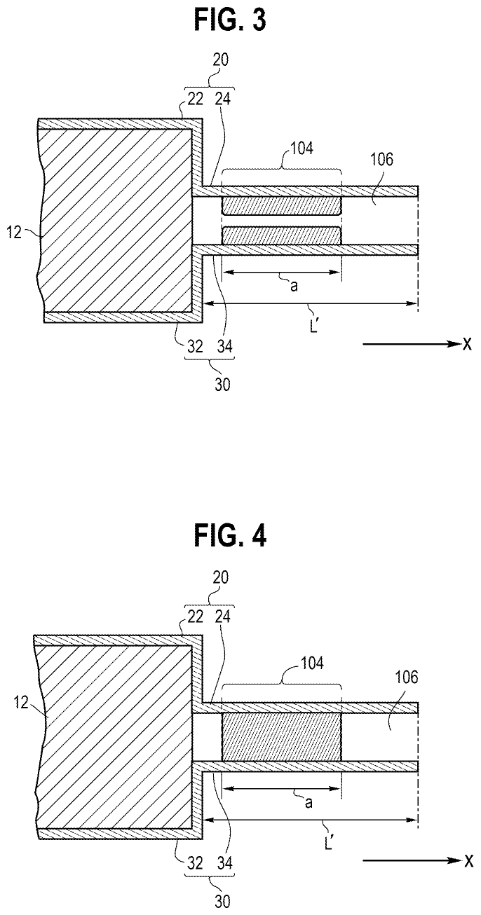

As shown in FIG. 2, for example, before servicing the power electronic device 12 (i.e. in the originally manufactured housing 10 having two welding zones 102 and 104) defined as a pre-service state of the housing 10, the upper enclosure 20 and the lower enclosure 30 are welded in the first welding zone 102 (i.e. an outermost welding zone) on the upper and lower flanges 24 and 34 such that the housing 10 encloses the power electronic device 12 and is sealed to prevent moisture from entering the housing 10 or the leakage of the coolant. When a service for the power electronic device 12 is required to access the inside of the housing 10 as shown in FIG. 3, the first welding zone 102 is removed by cutting a portion of the non-welding zone 106 (i.e. an adjacent non-welding zone) located between the first welding zone 102 and the second welding zone 104 on the flanges 24 and 34 such that the upper and lower enclosures 20 and 30 are separated (i.e. detached) from each other and the power electronic device 12 can be accessed without damaging any of the subsequent service weld seams (i.e. the second weld seams 105 in FIG. 2) to re-weld again after the service.

The detailed cross-sectional view of FIG. 3 after servicing the power electronic device 12 is defined as a post-service state of the housing 10. Referring to FIG. 4, after servicing the power electronic device 12, the second weld seams 105 pre-formed in the second welding zone 104 (i.e. the other outermost welding zone) are fused together such that the upper and lower enclosures 20 and 30 are re-attached and the housing 10 is reused to enclose the power electronic device 12, which is defined to as a completed post-service state of the housing 10. As shown in FIGS. 2-4, the length, L of the upper and lower flanges 24 and 34 in the longitudinal plane is reduced because the first welding zone 102 and a portion of the non-welding zone 106 are removed to separate the upper and lower enclosures 20 and 30 for the service such that the reduced length L′ is defined as the remaining length of the flanges 24 and 34 in the post-service state of the housing 10.

As shown in FIGS. 2-4, the housing 10 for the power electronic device 12 is reused according to the present disclosure. In the pre-service state of the housing 10 of FIG. 2, the first welding zone 102 on the upper and lower flanges 24 and 34 is removed by cutting the portion of the adjacent non-welding zone 106 (see a dot line in FIG. 2) for servicing the power electronic device 12 such that the upper and lower enclosures 20 and 30 are separated to access the inside of the housing 10. After the first welding zone 102 with the portion of the non-welding zone 106 are cut (see FIG. 3) for the service, the upper and lower enclosures 20 and 30 are reattached to form the housing 10 again by fusing the second weld seams 105 in the second welding zone 104 on the flanges 24 and 34, which have the reduced length L′ (see FIG. 4). Accordingly, the housing 10 can be reused to enclose the power electronic device 12 after servicing the power electronic device 12 without damaging any of the upper and lower enclosures 20 and 30.

The reusable housing 10 for the high voltage battery according to the exemplary embodiment of the present disclosure is suitable to use in the wide range of applications such as the vehicles including electric vehicles and hybrid electric vehicles, etc. Further, in the present disclosure, the reusable housing 10 with the multiple welding zones 100 may eliminate the need for many fasteners and subsequent sealant/gaskets, which are needed to seal the fasteners such that it reduces cost and weights of the components and also the battery housing assembly.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A housing for a power electronic device, the housing comprising:
an upper enclosure having an upper body and an upper flange extending outward from the upper body;
a lower enclosure having a lower body and a lower flange extending outward from the lower body;
wherein the upper and lower flanges are each defined with a length along a longitudinal plane of the flanges and materially bonded together along only an outer portion of the length to form a bonded part that seals and encloses the power electronic device, and
wherein, upon removing the bonded part of the flanges, the upper and lower flanges having a remaining length that can be re-bonded to again enclose the power electronic device.

2. The housing of claim 1, wherein the housing includes at least two bonding zones spaced apart on the length of the flanges along the longitudinal plane and at least one non-bonding zone located between the at least two bonding zones.

3. The housing of claim 2, wherein, in a pre-service state of the housing, the upper and lower flanges are attached at least at sections of the perimeters of the flanges by materially bonding in an outermost bonding zone.

4. The housing of claim 3, wherein the outermost bonding zone on the flanges is configured to be removed and provide access the power electronic device inside the housing such that it can be serviced.

5. The housing of claim 3, wherein the bonded outermost bonding zone of the flanges is configured to be removed by cutting an adjacent portion of the at least one non-bonding zone in the longitudinal plane.

6. The housing of claim 2, wherein, in a completed post-service state of the housing, the upper and lower flanges are re-bonded in an other bonding zone arranged in the remaining length of the flanges.

7. The housing of claim 6, wherein the other bonding zone has become a second outermost bonding zone via removal of a first outermost bonding zone in a pre-serviced state of the housing.

8. The housing of claim 2, wherein each of the bonding zones includes weld seams pre-formed on each of the upper and lower flanges such that the weld seams are fused together to attach the upper and lower flanges when welded.

9. The housing of claim 1, wherein the upper and lower enclosures are formed of a thermoplastic polymer material.

10. The housing of claim 1, wherein the upper and lower enclosures are attached to each other by one of material bonding methods such as a welding or a gluing with an adhesive material.

11. A housing for a power electronic device, the housing comprising:
an upper enclosure and a lower enclosure attached to enclose the power electronic device; and
at least two welding zones arranged on flanges formed in each of the upper and lower enclosures, the at least two welding zones spaced apart along a longitudinal plane of the flanges;
wherein the flanges are welded together in an outermost welding zone, thereby providing a pre-service state of the housing,
wherein the outermost welding zone in the pre-service state of the housing is configured to be removed by cutting a portion of an adjacent non-welding zone to access the power electronic device inside the housing during a service, and
wherein the flanges are configured to be re-welded in an other outermost welding zone to enclose the power electronic device, thereby providing a completed post-service state of the housing.

12. The housing of claim 11, wherein at least one non-welding zone on the flanges is located between the at least two welding zones in the longitudinal plane.

13. The housing of claim 11, wherein the at least two welding zones and the at least one non-welding zone are each arranged around perimeters of the upper and lower flanges.

14. (canceled)

15. The housing of claim 11, wherein a length of the flanges along the longitudinal axis in the pre-service state of the housing is reduced by cutting a welded part and the portion of the adjacent non-welding zone on the flanges.

16. The housing of claim 11, further comprising weld seams preformed in each welding zone on the flanges such that the weld seams are fused together by a welding method.

17. A method for reusing a housing for the power electronic device, the method comprising the steps of:
providing an upper enclosure formed with an upper flange;
providing a lower enclosure formed with a lower flange;
arranging a first welding zone and a second welding zone spaced apart by a non-welding zone around perimeters of a portion of the upper and lower flanges along a longitudinal plane of the flanges;
attaching the upper and lower enclosures by welding in the first welding zone located in an outermost portion of the flanges;
removing the first welding zone on the upper and lower flanges such that the upper and lower enclosures are detached from each other and the power electronic device can be accessed; and
attaching the upper and lower enclosures by re-welding in the second welding zone on the upper and lower flanges to again enclose the power electronic device.

18. The method of claim 17, further comprising the step of removing the first welding zone on the flanges further includes the step of cutting a portion of the non-welding zone defined between the first and second welding zones such that the first welding zone and the portion of the non-welding zone are removed.

19. The method of claim 17, wherein each of the first and second welding zones includes a seam weld pre-formed on each of the flanges to attach the upper and lower enclosures when welded.

20. The method of claim 17, wherein the upper and lower flanges are attached to each other with one of various welding methods such as a laser welding, an ultrasonic plastic welding, an infrared welding, or a hot plate welding.

21. (canceled)

22. The housing of claim 1, wherein the housing is used to enclose at least one battery pack such as a high voltage battery pack.
